(19) United States
(12) Patent Application Publication
(10) Pub. No.: US 2003/0169718 A1
(43) Pub. Date: Sep. 11, 2003

(54) System for returning rates back to content providers, gateway used for the system, and method of doing the same

(75) Inventors: Junichi Hirata, Tokyo (JP); Katsunori Nishimura, Tokyo (JP); Yoji Tanaka, Tokyo (JP)

Correspondence Address: FOLEY AND LARDNER, SUITE 500, 3000 K STREET NW, WASHINGTON, DC, 20007, US

(73) Assignee: NEC CORPORATION

(21) Appl. No.: 10/378,824

(22) Filed: Mar. 5, 2003

(30) Foreign Application Priority Data
Mar. 6, 2002 (JP) 2002-60450

(51) Int. Cl. H04Q 7/24

(52) U.S. Cl. 370/338; 370/352

(57) ABSTRACT

A system for returning a rate back to a content provider, includes (a) at least one user terminal receiving and transmitting packets, (b) a plurality of content providers each of which provides contents to an internet, and (c) a packet communication network connected to both the user terminal and the internet through radio signals, the packet communication network allowing packets to pass therethrough between the user terminal and the content providers, and charging the user terminal making access to the content providers, for packet rates. When the user terminal receives packets provided from a content provider to which at least a part of the packet rates is to be returned back, the part of the packet rates is returned back to the content provider.

### BACKGROUND OF THE INVENTION

1. Field of the Invention

The invention relates to a system for returning rates back to a small-sized content provider which distributes contents through an internet. The invention relates further to a gateway used in such a system, and a method of doing the same.

2. Description of the Related Art

A charging system in packet communication includes, for instance, a system in which a rate is determined in accordance with the numbers of packets a packet communication user receives, a system in which a communication administrator charges a user for packet communication in place of a content provider, and a system in which a content provider carries out authentication for charging a user packet communication rate. These systems are carried out by a communication administrator or a content provider which can receive communication rates in an end-to-end manner.

Recently, a communication administrator newly presents service in which a cellular phone such as an “i-mode” type cellular phone can make access to an internet. As a result, as a greater number of users have a cellular phone, access is made in the greater number to an internet from cellular phones in packet communication. One of reasons why the number of access is increased is that a lot of small-sized voluntary content providers present various contents to cellular phones through an internet. Such various contents satisfy various demands of a lot of cellular phone users.

Such various contents are presented for the purpose of reducing costs necessary for maintaining shops in which a content provider makes direct contact with users, for instance. In general, a content provider earns an income as running costs for providing contents, in accordance with the following ways.

First, a content provider can earn an income by inserting an advertisement in his/her content.

Second, a content provider can earn an income by running a toll site for presenting music or games to a cellular phone, in which case, a communication administrator charges a cellular phone user a rate for communication in place of the content provider.

Third, a content provider can have a server which is capable of authenticating a packet communication network user for charging the user a communication rate in an end-to-end manner.

However, some content providers among a lot of content providers do not charge users a rate for presenting contents to him/her. Such content providers are called voluntary content providers. If such voluntary content providers are not able to earn running costs in accordance with the above-mentioned ways, they cannot earn an income for newly constructing or running their sites.

In order for a communication administrator to earn a packet communication rate much, it would be necessary that content providers including the above-mentioned voluntary content providers present attractive contents to users, and resultingly, users make much access to the contents. Hence, if a communication administrator returns a part of a packet communication rate back to voluntary content providers for assistance of their growth, it would be a significant merit for a communication administrator.

For instance, Japanese Patent Application Publication No. 10-334145 has suggested a server which is capable of charging a user a communication rate on behalf of a content provider.

However, the suggested server just charges a packet network user a communication rate for purchasing contents on a network, and is not designed to have a function of returning a part of a communication rate back to a voluntary content provider which cannot earn an income.

Japanese Patent Application Publication No. 11-66182 has suggested a system for charging a user a communication rate and receiving the communication rate on behalf of a content provider.

Japanese Patent Application Publication No. 11-296583 has suggested a system of charging a user a communication rate. When a user purchases goods in a cyber shop through the use of an identifier or a password of a registered provider, the suggested system allows a user to purchase goods from a plurality of providers at a time.

Japanese Patent Application Publication No. 2000-13371 has suggested a method of charging a user a communication rate, including the steps of monitoring a period of time necessary for downloading content data to a user, calculating a period of time per one unit of data, and controlling a period of time necessary for downloading content data which time is varied due to a speed at which content data is transmitted.

Japanese Patent Application Publication No. 2000-76339 has suggested a method of calculating a communication rate, including the steps of monitoring how degree certain content data is used, and calculating a rate to a content holder in accordance with the results of monitoring.

Japanese Patent Application Publication No. 2001-67401 has suggested a method of on-line charging a user a communication rate, including the steps of connecting a communication terminal to a center storing content data, calculating a communication rate in accordance with a size of a package of content data when the center transmits the content data to the communication terminal, and charging the communication terminal a sum of the thus calculated communication rate and a rate for the content data.

Japanese Patent Application Publication No. 2001-77953 has suggested a system for presenting toll images, including first means for outputting a combination of image data and additional image data, and second means for calculating a rate by subtracting a rate associated with the additional image data out of a rate associated with the image data.

Japanese Patent Application Publication No. 2001-186125 has suggested a method of charging a user a communication rate in a data communication network including a server of a data-providing administrator, a plurality of user terminals receiving data from the server, and a relay unit through which the server transmits data to the user terminals. The relay unit carries out the steps of storing first data about the data-providing administrator, receiving second data from the server which second data is indicative of whether a rate is a rate to be charged to the data-providing administrator, judging, when data received from the server is transmitted in accordance with the first data, whether a rate is to be charged to the data-providing administrator for the data, based on the second data, and charging the data-providing administrator the rate when it is judged that the rate should be charged to the data-providing administrator for the data.

Japanese Patent Application Publication No. 2001-285825 has suggested a system including first means for accumulating contents to which advertisement data is added, and providing the contents to a client through a network in response to a request of the client, and second means for calculating points given in accordance with the number of times by which the first means provides the contents to the client, and returning profits back to a content provider in accordance with the points.

However, a system for a communication administrator to return a part of a packet communication rate back to a voluntary content provider is not disclosed and suggested yet.

### SUMMARY OF THE INVENTION

In view of the above-mentioned problems in the prior systems, it is an object of the present invention to provide a system which enables a communication administrator to return a part of a packet communication rate back to a voluntary content provider.

It is also an object of the present invention to provide a method of enabling a communication administrator to return a part of a packet communication rate back to a voluntary content provider.

It is further an object of the present invention to provide a gateway used in the above-mentioned system and method.

In one aspect of the present invention, there is provided a system for returning a rate back to a provider, including (a) at least one user terminal receiving and transmitting packets, (b) a plurality of content providers each of which provides contents through an internet, and (c) a packet communication network connected to both the user terminal and the internet through radio signals, the packet communication network allowing packets to pass therethrough between the user terminal and the content providers, and charging the user terminal making access to the providers, for packet rates, wherein when the user terminal receives packets provided from a provider to which at least a part of the packet rates is to be returned back, the part of the packet rates is returned back to the provider.

In accordance with the above-mentioned system, when a user terminal receives packets provided from a content provider to which at least a part of a packet rate is to be returned back, the part of the packet rate is returned back to the content provider. As a result, a lot of small-sized voluntary content providers can earn an income, and hence, a communication administrator can assist voluntary content providers to construct attractive contents. If voluntary content providers can present a lot of attractive contents, the number of accesses made to such voluntary content providers is increased, ensuring that a communication administrator which presents a packet communication network can earn an increased income.

There is further provided a system for returning a rate back to a content provider, including (a) at least one user terminal receiving and transmitting packets, (b) a plurality of content providers each of which provides contents through an internet, and (c) a packet communication network including a gateway, the packet communication network being connected to the user terminal through radio signals, and further to the internet through the gateway through radio signals, the packet communication network allowing packets to pass therethrough between the user terminal and the content providers, and charging the user terminal making access to the content providers, for packet rates, wherein the gateway, when the user terminal receives packets provided from a certain content provider, judges whether the certain content provider is a content provider to which at least a part of the packet rates is to be returned back, and if the certain content provider is a content provider to which at least a part of the packet rates is to be returned back, the part of the packet rates is returned back to the certain content provider.

In accordance with the above-mentioned system, when a user terminal receives packets provided from a certain content provider, the gateway judges whether the certain content provider is a content provider to which at least a part of the packet rates is to be returned back. If the certain content provider is such a content provider, the part of the packet rate is returned back to the certain content provider. As a result, a lot of small-sized voluntary content providers can earn an income, and hence, a communication administrator can assist voluntary content providers to construct attractive contents. If voluntary content providers can present a lot of attractive contents, the number of accesses made to such voluntary content providers is increased, ensuring that a communication administrator which presents a packet communication network can earn an increased income.

It is preferable that the gateway compares a content identifier applied to the certain content provider to a content identifier included in packets transmitted from the user terminal, for judging whether the user terminal receives packets provided from a content provider to which at least a part of the packet rates is to be returned back.

It is preferable that the packet communication network includes a database in which the content identifier applied to the certain content provider is stored.

It is preferable that the packet communication network includes a log file to which the gateway transmits access data when the content identifier applied to the certain content provider is identical with the content identifier included in packets transmitted from the user terminal, and wherein the part of the packet rates is returned back to the certain content provider in accordance with the access data.

For instance, the content identifier may be comprised of a universal resource locator (URL).

For instance, the access data may include an amount of packets transmitted to the user terminal.

For instance, the access data may include the number of access made to each of the content providers.

For instance, the access data may include a period of time in which the user terminal makes communication with the certain content provider.

In another aspect of the present invention, there is provided a method of returning a rate back to a content provider in a system including (a) at least one user terminal receiving and transmitting packets, (b) a plurality of content providers each of which provides contents through an internet, and (c) a packet communication network connected to both the user terminal and the internet through radio signals, the packet communication network allowing packets to pass therethrough between the user terminal and the content providers, and charging the user terminal making access to the content providers, for packet rates, the method including the step of, when the user terminal receives packets provided from a content provider to which at least a part of the packet rates is to be returned back, returning the part of the packet rates back to the content provider.

There is further provided a method of returning a rate back to a content provider in a system including (a) at least one user terminal receiving and transmitting packets, (b) a plurality of content providers each of which provides contents through an internet, and (c) a packet communication network connected to both the user terminal and the internet through radio signals, the packet communication network allowing packets to pass therethrough between the user terminal and the content providers, and charging the user terminal making access to the content providers, for packet rates, the method including the steps of (a) when the user terminal receives packets provided from a certain content provider, judging whether the certain content provider is a content provider to which at least a part of the packet rates is to be returned back, and (b) if the certain content provider is a content provider to which at least a part of the packet rates is to be returned back, returning the part of the packet rates back to the certain content provider.

It is preferable that the step (a) includes a sub-step of comparing a content identifier applied to the certain content provider to a content identifier included in packets transmitted from the user terminal, for judging whether the user terminal receives packets provided from a content provider to which at least a part of the packet rates is to be returned back.

It is preferable that the method further includes the steps of storing the content identifier applied to the certain content provider, into a database, and reading the content identifier out of the database, when the sub-step is carried out.

It is preferable that the method further includes the step of transmitting access data to a log file, when the content identifier applied to the certain content provider is identical with the content identifier included in packets transmitted from the user terminal, in which case, the part of the packet rates is returned back to the certain content provider in the step (b) in accordance with the access data.

In still another aspect of the present invention, there is provided a gateway arranged in a packet communication network through which a plurality of content providers each of which provides contents through an internet transmits packets to and receives packets from a user terminal, the gateway acting as an interface through which the packet communication network makes communication with the internet, the packet communication network charging the user terminal making access to the content providers, for packet rates, wherein the gateway, when the user terminal receives packets provided from a certain content provider, judges whether the certain content provider is a content provider to which at least a part of the packet rates is to be returned back, and if the certain content provider is judged by the gateway to be a content provider to which at least a part of the packet rates is to be returned back, the part of the packet rates is returned back to the certain content provider.

It is preferable that the gateway compares a content identifier applied to the certain content provider to a content identifier included in packets transmitted from the user terminal, for judging whether the user terminal receives packets provided from a content provider to which at least a part of the packet rates is to be returned back.

It is preferable that the gateway reads the content identifier applied to the certain content provider, out of a database arranged in the packet communication network.

It is preferable that the gateway transmits access data to a log file arranged in the packet communication network, when the content identifier applied to the certain content provider is identical with the content identifier included in packets transmitted from the user terminal, in which case, the part of the packet rates is returned back to the certain content provider in accordance with the access data.

The advantages obtained by the aforementioned present invention will be described hereinbelow.

In accordance with the present invention, when a user terminal receives packets provided from a certain content provider, it is judged as to whether the certain content provider is a content provider to which at least a part of the packet rates is to be returned back. If the certain content provider is such a content provider, the part of the packet rate is returned back to the certain content provider. As a result, a lot of small-sized voluntary content providers can earn an income, and hence, a communication administrator can assist voluntary content providers to construct attractive contents. If voluntary content providers can present a lot of attractive contents, the number of accesses made to such voluntary content providers is increased, ensuring that a communication administrator which presents a packet communication network can earn an increased income.

The above and other objects and advantageous features of the present invention will be made apparent from the following description made with reference to the accompanying drawings, in which like reference characters designate the same or similar parts throughout the drawings.

### BRIEF DESCRIPTION OF THE DRAWINGS

FIG. 1 is a block diagram illustrating a system for returning a packet communication rate back to a voluntary content provider, in accordance with the first embodiment of the present invention.

FIG. 2 is a flow-chart showing an operation of the system in accordance with the first embodiment.

FIG. 3 is a block diagram illustrating a system for returning a packet communication rate back to a voluntary content provider, in accordance with the second embodiment of the present invention.

FIG. 4 is a flow-chart showing an operation of the system in accordance with the second embodiment.

### DESCRIPTION OF THE PREFERRED EMBODIMENTS

Preferred embodiments in accordance with the present invention will be explained hereinbelow with reference to drawings.

[First Embodiment]

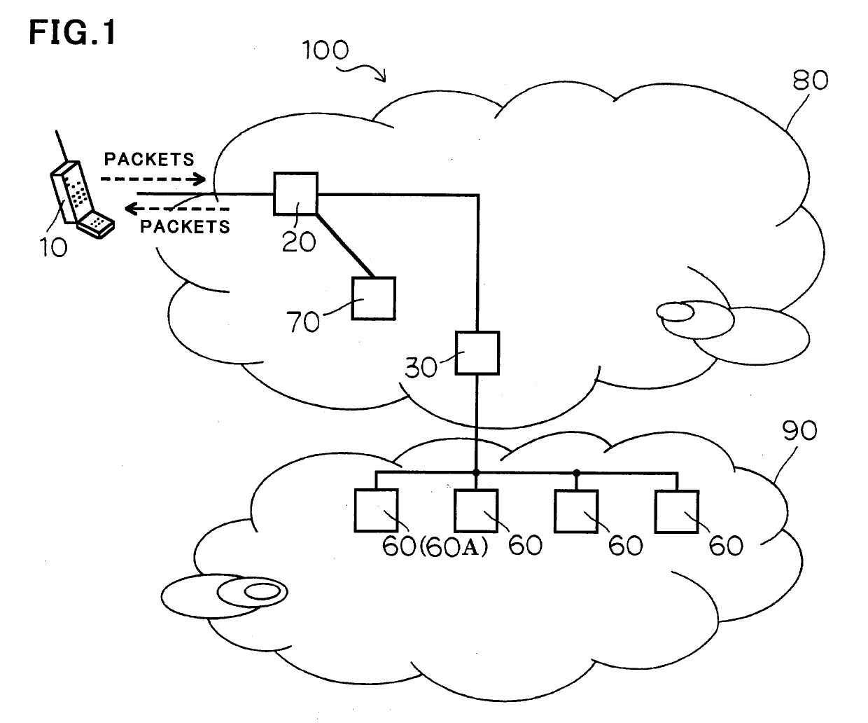

FIG. 1 is a block diagram illustrating a system 100 for returning a packet communication rate back to a voluntary content provider, in accordance with the first embodiment of the present invention.

The system 100 in accordance with the first embodiment is comprised of a user terminal 10, a packet communication network 80, and a plurality of content providers 60 each of which provides contents through an internet network 90.

The packet communication network 80 connects the user terminal 10 to the internet network 90, and is provided by a communication administrator. The packet communication network 80 is comprised of an exchange 20, an interface 30, and a charger 70.

The exchange 20 and the interface 30 are designed to make communication to each other. The exchange 20 acts as an interface through which the packet communication network 80 makes communication with the user terminal 10 through radio signals, and the interface 30 allows the packet communication network 80 to make communication with the internet network 90.

The user terminal 10 transmits packets to the content providers 60 through the exchange 20 and the interface 30, and the content providers 60 transmit packets to the user terminal 10 through the interface 30 and the exchange 20. The charger 70 is connected to the exchange 20.

The user terminal 10 is comprised of a data processor which is capable of making packet communication to receive various services, such as a cellular phone or a personal computer. Each of the content providers 60 is comprised of a data processor arranged in the internet network 90, such as a workstation server, and provides contents through the internet network 90.

The user terminal 10 is designed to be able to make access to the content providers 60 through the packet communication network 80, and have a display screen in which contents having been received from the content providers 60 can be displayed.

The exchange 20 receives a request of making access to the content providers 60, from the user terminal 10, and receives packets transmitted from the content providers 60 in response to the request and transmits the packets to the user terminal 10.

The charger 70 is arranged by a communication administrator providing the packet communication network 80. The charger 70 calculates an amount of packets to be transmitted to the user terminal 10 in response to the above-mentioned request, and charges a user of the user terminal 10 a packet communication rate in accordance with the calculated amount of packets.

The interface 30 is comprised of a data processor such as a workstation server. The interface 30 charges a user a communication rate on behalf of a toll content provider. It is assumed that a content provider 60A among the content providers 60 is a voluntary content provider to which a part of a packet communication rate which a communication administrator charges a user of the user terminal 10 is to be returned back. If the user terminal 10 receives packets provided from the voluntary content provider 60A, the interface 30 transmits an instruction to the charger 70 through the exchange 20 to pay a part of a packet communication rate to the voluntary content provider 60A.

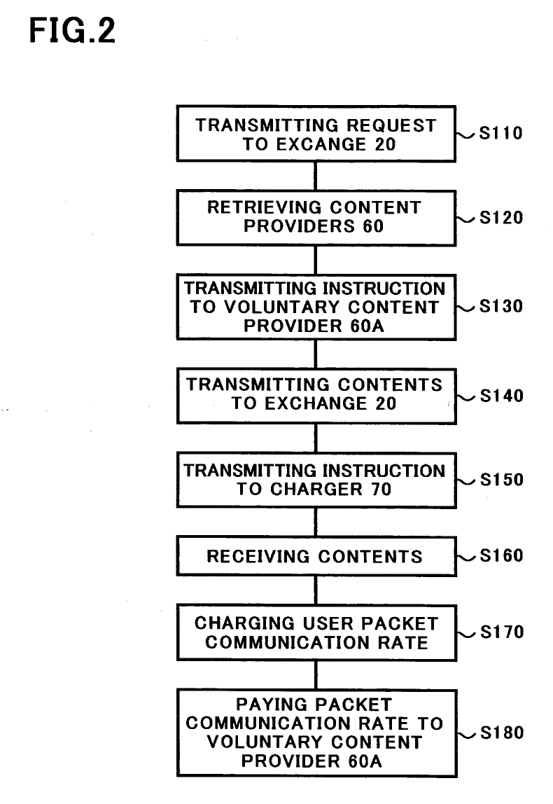

FIG. 2 is a flow-chart showing an operation of the system 100 in accordance with the first embodiment. Hereinbelow is explained the operation of the system 100 with reference to FIG. 2.

First, the terminal user 10 transmits a request of presenting contents thereto, to the exchange 20, in step S110.

On receipt of the request from the user terminal 10, the exchange 20 retrieves the content providers 60 to find a content provider which provides the contents requested by the user terminal 10, in step S120. It is assumed that the thus found content provider is a voluntary content provider 60A to which a part of a packet communication rate which a communication administrator charges a user of the user terminal 10 is to be returned back.

Then, the exchange 20 transmits an instruction to the voluntary content provider 60A through the interface 30 to provide contents to the exchange 20, in step S130.

On receipt of the instruction from the exchange 20, the voluntary content provider 60A transmits contents to the exchange 20 through the interface 30, in step S140.

Since the contents or packets passing through the interface 30 are transmitted from the voluntary content provider 60A, the interface 30 transmits an instruction to the charger 70 through the exchange 20 that the packets are transmitted from the voluntary content provider 60A, and hence, a part of a packet communication rate should be paid to the voluntary content provider 60A, in step S150.

The user terminal 10 receives the contents transmitted from the voluntary content provider 60A through the interface 30 and the exchange 20, in step S160.

The charger 70 charges a user of the user terminal 10 a packet communication rate, in step S170. In accordance with the instruction transmitted from the interface 30, the charger 70 pays a part of the thus charged packet communication rate to the voluntary content provider 60A, in step S180.

[Second Embodiment]

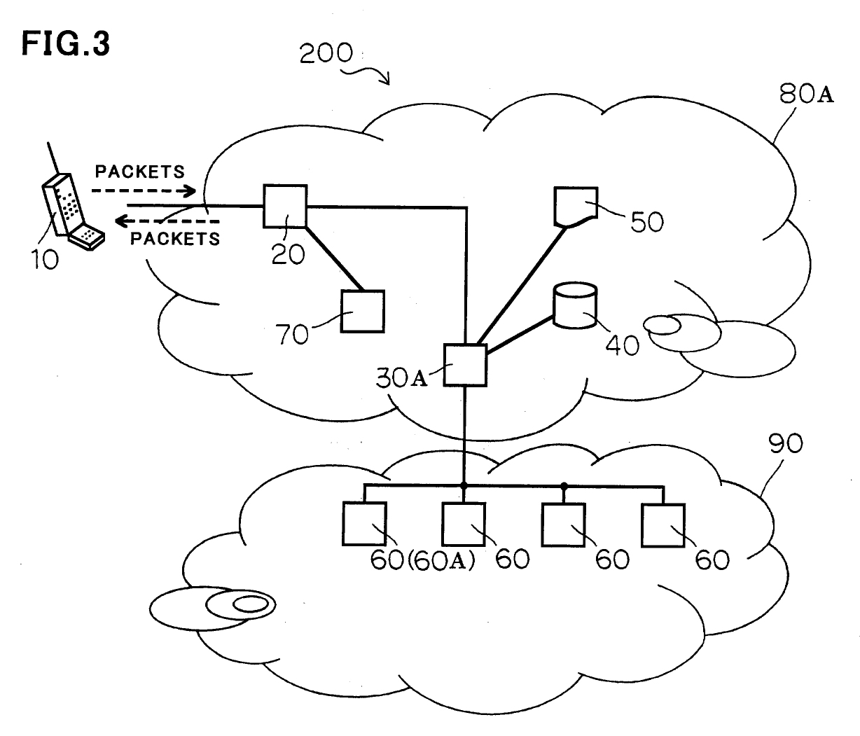

FIG. 3 is a block diagram illustrating a system 200 for returning a packet communication rate back to a voluntary content provider, in accordance with the second embodiment of the present invention.

The system 200 in accordance with the second embodiment is comprised of a user terminal 10, a packet communication network 80A, and a plurality of content providers 60 each of which provides contents through an internet network 90.

The packet communication network 80A connects the user terminal 10 to the internet network 90, and is provided by a communication administrator. The packet communication network 80A is comprised of an exchange 20, a gateway 30A, and a charger 70.

The exchange 20 and the gateway 30A are designed to make communication to each other. The exchange 20 acts as an interface through which the packet communication network 80A makes communication with the user terminal 10 through radio signals, and the gateway 30A acts as an interface through which the packet communication network 80A makes communication with the internet network 90.

The user terminal 10 transmits packets to the content providers 60 through the exchange 20 and the gateway 30A, and the content providers 60 transmit packets to the user terminal 10 through the gateway 30A and the exchange 20. The charger 70 is connected to the exchange 20. The gateway 30A includes a database 40 and a log file 50.

The user terminal 10, the content providers 60, the exchange 20 and the charger 70 have the same structure as the structure of them in the first embodiment, and operate in the same manner as the corresponding parts in the first embodiment.

The gateway 30A is comprised of a data processor such as a workstation server. The gateway 30A charges a user a communication rate on behalf of a toll content provider.

In addition, the gateway 30A compares a content identifier stored in the database 40 to a content identifier indicated in a packet transmitted from the user terminal 10 as a request to provide contents to the user terminal 10. Herein, a content identifier means an identifier which identifies only one content provider. In the second embodiment, a content identifier is comprised of a host in a hyper text transfer protocol (HTTP) in the request transmitted from the user terminal 10. For instance, it is assumed that the request is comprised of a phrase “GET “http://www.xxx.co.jp/index.html HTTP//1.0” made in accordance with the hyper text transfer protocol, a content identifier is comprised of “www.xxx.co.jp” which is a host of the request. That is, a content identifier is comprised of a universal resource locator (URL).

A content identifier of a content provider to which a part of a packet communication rate which a communication administrator charges a user of the user terminal 10 is to be returned back is stored in the database 40. For instance, if it is assumed that a content provider 60A among the content providers 60 is a voluntary content provider to which a part of a packet communication rate which a communication administrator charges a user of the user terminal 10 is to be returned back, a content identifier of the voluntary content provider 60A is in advance stored in the database 40.

If the gateway 30A judges that a content identifier indicated in the request transmitted from the user terminal 10 is identical with a content identifier of the voluntary content provider 60A, stored in the database 40, the gateway 30A transmits access data to the log file 50. The access data includes the content identifier and an amount of packets which the voluntary content provider 60A transmitted to the user terminal 10 through the gateway 30A. The log file 50 stores the received access data therein.

The access data including the content identifier and an amount of the packets may be displayed in a display screen of the user terminal 10.

If packets passing through the gateway 30A are to be received by the user terminal 10, only access data of packets having a content identifier compared to a content identifier of packets having been transmitted from the user terminal 10 in the past is transmitted to the log file 50.

The access data is transmitted to the log file 50 each time a request to make access to the content providers 60 is transmitted from the user terminal 10. An amount of packets stored in the log file 50 is used for detecting an amount of packets transmitted each of the content providers 60.

A communication administrator providing the packet communication network 80A returns a part of a packet communication rate back to the voluntary content provider 60A in accordance with the access data stored in the log file 50, for instance, in accordance with a ratio of packets transmitted from the voluntary content provider 60A to packets transmitted from all of the content providers 60.

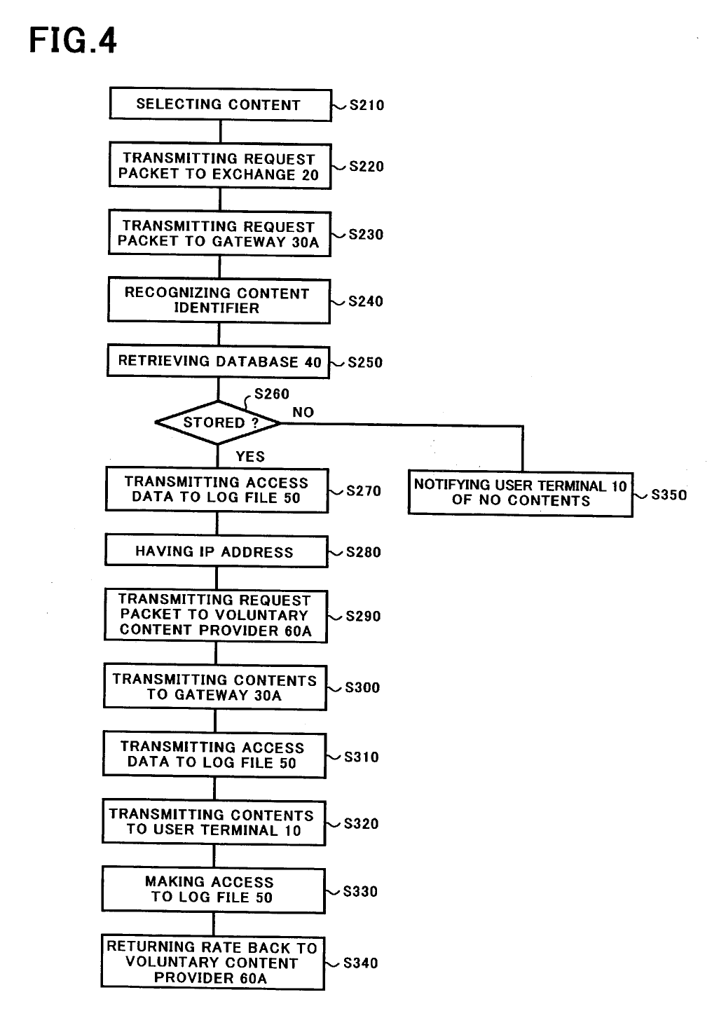

FIG. 4 is a flow-chart showing an operation of the system 200 in accordance with the second embodiment. Hereinbelow is explained the operation of the system 200 with reference to FIG. 4.

First, a user of the user terminal 10 selects a content which the user desired to have, in a menu displayed in a display screen of the user terminal 10, in step S210. Then, the user terminal 10 transmits a request packet which requests to provide the selected content thereto, to the exchange 20, in step S220. Specifically, the user terminal 10 transmits a packet to the exchange 20 which packet has an argument to which a universal resource locator (URL) of the selected content is applied in accordance with “GET method” presenting a hyper text transfer protocol (HTTP) request defined by RFC (Request For Comments) in IETF (Internet Engineering Task Force).

On receipt of the request packet, the exchange 20 establishes session with the gateway 30A, and transmitting the request packet to the gateway 30A, in step S230.

On receipt of the request packet, the gateway 30A recognizes the universal resource locator (the above-mentioned “www.xxx.co.jp”) included in the received request packet, as a content identifier, in step S240.

Then, the gateway 30A retrieves the database 40 to check whether a content identifier identical with the thus recognized content identifier is stored in the database 40, in step S250.

If a universal resource locator of contents provided from the voluntary content provider 60A is not stored in the database 40 (NO in step S260), the gateway 30A notifies the user terminal 10 through the exchange 20 that contents which a user of the user terminal 10 requested to have cannot be obtained, in step S350.

If a universal resource locator of contents provided from the voluntary content provider 60A is stored in the database 40 as a content identifier (YES in step S260), the gateway 30A transmits access data to the log file 50, in step S270. The access data includes the universal resource locator and an amount of packets of the contents.

Then, the gateway 30A retrieves the universal resource locator in a domain name server (DNS) (not illustrated) in order to have an internet protocol (IP) address of the voluntary content provider 60A to which the user terminal 10 requested to provide contents thereto, in step S280.

Thereafter, the gateway 30A establishes a connection with the voluntary content provider 60A by virtue of the internet protocol address, and transmits the request packet to the voluntary content provider 60A through the internet network 90, in step S290.

In response to the request transmitted from the user terminal 10, the voluntary content provider 60A transmits contents to the gateway 30A through the session having been already established, in step S300. The gateway 30A transmits an amount of packets of the contents received from the voluntary content provider 60A, to the log file 50 as access data, in step S310. The contents provided from the voluntary content provider 60A are transmitted to the user terminal 10 through the gateway 30A and the exchange 20, in step S320.

Thus, a user of the user terminal 10 can watch, listen to or download the contents which he/she requested to have.

A communication administrator presenting the packet communication network 80A periodically makes access to the log file 50 to collect the access data stored in the log file 50, in step S330.

Then, a communication administrator returns a part of a packet communication rate which a communication administrator charged a user of the user terminal 10 through the charge 70, back to the voluntary content provider 60A in accordance with an amount of packets indicated in the access data, in step S340.

In the system 200 in accordance with the second embodiment, a packet communication rate is returned back to the voluntary content provider 60A in accordance with an amount of packets of the contents transmitted from the voluntary content provider 60A. However, it should be noted that the number of accesses or hits made to the voluntary content provider 60A or a period of time during which the user terminal 10 makes communication with the voluntary content provider 60A may be used in place of an amount of packets of the contents.

In accordance with the above-mentioned system 200, when the user terminal 10 receives packets provided from a certain content provider, the gateway 30A judges whether the certain content provider is the voluntary content provider 30A. If the certain content provider is the voluntary content provider 30A, a part of a packet communication rate is returned back to the voluntary content provider 60A in accordance with an amount of packets of the contents which the voluntary content provider 60A transmitted. As a result, a lot of small-sized voluntary content providers can earn an income, and hence, a communication administrator can assist voluntary content providers to construct attractive contents. If voluntary content providers can present a lot of attractive contents, the number of accesses made to such voluntary content providers is increased, ensuring that a communication administrator which presents the packet communication network 80A can earn an increased income.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

The entire disclosure of Japanese Patent Application No. 2002-60450 filed on Mar. 6, 2002 including specification, claims, drawings and summary is incorporated herein by reference in its entirety.

What is claimed is:

1. A system for returning a rate back to a content provider, comprising:
(a) at least one user terminal receiving and transmitting packets;
(b) a plurality of content providers each of which provides contents through an internet; and
(c) a packet communication network connected to both said user terminal and said internet through radio signals, said packet communication network allowing packets to pass therethrough between said user terminal and said content providers, and charging said user terminal making access to said content providers, for packet rates,
wherein when said user terminal receives packets provided from a content provider to which at least a part of said packet rates is to be returned back, said part of said packet rates is returned back to said content provider.

2. A system for returning a rate back to a content provider, comprising:
(a) at least one user terminal receiving and transmitting packets;
(b) a plurality of content providers each of which provides contents through an internet; and
(c) a packet communication network including a gateway, said packet communication network being connected to said user terminal through radio signals, and further to said internet through said gateway through radio signals, said packet communication network allowing packets to pass therethrough between said user terminal and said content providers, and charging said user terminal making access to said content providers, for packet rates,
wherein said gateway, when said user terminal receives packets provided from a certain content provider, judges whether said certain content provider is a content provider to which at least a part of said packet rates is to be returned back, and if said certain content provider is a content provider to which at least a part of said packet rates is to be returned back, said part of said packet rates is returned back to said certain content provider.

3. The system as set forth in claim 2, wherein said gateway compares a content identifier applied to said certain content provider to a content identifier included in packets transmitted from said user terminal, for judging whether said user terminal receives packets provided from a content provider to which at least a part of said packet rates is to be returned back.

4. The system as set forth in claim 3, wherein said packet communication network includes a database in which said content identifier applied to said certain content provider is stored.

5. The system as set forth in claim 3, wherein said packet communication network includes a log file to which said gateway transmits access data when said content identifier applied to said certain content provider is identical with said content identifier included in packets transmitted from said user terminal, and wherein said part of said packet rates is returned back to said certain content provider in accordance with said access data.

6. The system as set forth in claim 3, wherein said content identifier is comprised of a universal resource locator (URL).

7. The system as set forth in claim 5, wherein said access data includes an amount of packets transmitted to said user terminal.

8. The system as set forth in claim 5, wherein said access data includes the number of access made to each of said content providers.

9. The system as set forth in claim 5, wherein said access data includes a period of time in which said user terminal makes communication with said certain content provider.

10. A method of returning a rate back to a content provider in a system including (a) at least one user terminal receiving and transmitting packets, (b) a plurality of content providers each of which provides contents through an internet, and (c) a packet communication network connected to both said user terminal and said internet through radio signals, said packet communication network allowing packets to pass therethrough between said user terminal and said content providers, and charging said user terminal making access to said content providers, for packet rates,
said method comprising the step of, when said user terminal receives packets provided from a content provider to which at least a part of said packet rates is to be returned back, returning said part of said packet rates back to said content provider.

11. A method of returning a rate back to a content provider in a system including (a) at least one user terminal receiving and transmitting packets, (b) a plurality of content providers each of which provides contents through an internet, and (c) a packet communication network connected to both said user terminal and said internet through radio signals, said packet communication network allowing packets to pass therethrough between said user terminal and said content providers, and charging said user terminal making access to said content providers, for packet rates, said method comprising the steps of:
(a) when said user terminal receives packets provided from a certain content provider, judging whether said certain content provider is a content provider to which at least a part of said packet rates is to be returned back; and
(b) if said certain content provider is a content provider to which at least a part of said packet rates is to be returned back, returning said part of said packet rates back to said certain content provider.

12. The method as set forth in claim 11, wherein said step (a) includes a sub-step of comparing a content identifier applied to said certain content provider to a content identifier included in packets transmitted from said user terminal, for judging whether said user terminal receives packets provided from a content provider to which at least a part of said packet rates is to be returned back.

13. The method as set forth in claim 12, further comprising the steps of:
storing said content identifier applied to said certain content provider, into a database; and
reading said content identifier out of said database, when said sub-step is carried out.

14. The method as set forth in claim 12, further comprising the step of transmitting access data to a log file, when said content identifier applied to said certain content provider is identical with said content identifier included in packets transmitted from said user terminal, and wherein said part of said packet rates is returned back to said certain content provider in said step (b) in accordance with said access data.

15. The method as set forth in claim 12, wherein said content identifier is comprised of a universal resource locator (URL).

16. The method as set forth in claim 14, wherein said access data includes an amount of packets transmitted to said user terminal.

17. The method as set forth in claim 14, wherein said access data includes the number of access made to each of said content providers.

18. The method as set forth in claim 14, wherein said access data includes a period of time in which said user terminal makes communication with said certain content provider.

19. A gateway arranged in a packet communication network through which a plurality of content providers each of which provides contents through an internet transmits packets to and receives packets from a user terminal, said gateway acting as an interface through which said packet communication network makes communication with said internet, said packet communication network charging said user terminal making access to said content providers, for packet rates,
wherein said gateway, when said user terminal receives packets provided from a certain content provider, judges whether said certain content provider is a content provider to which at least a part of said packet rates is to be returned back, and
if said certain content provider is judged by said gateway to be a content provider to which at least a part of said packet rates is to be returned back, said part of said packet rates is returned back to said certain content provider.

20. The gateway as set forth in claim 19, wherein said gateway compares a content identifier applied to said certain content provider to a content identifier included in packets transmitted from said user terminal, for judging whether said user terminal receives packets provided from a content provider to which at least a part of said packet rates is to be returned back.

21. The gateway as set forth in claim 20, wherein said gateway reads said content identifier applied to said certain content provider, out of a database arranged in said packet communication network.

22. The gateway as set forth in claim 20, wherein said gateway transmits access data to a log file arranged in said packet communication network, when said content identifier applied to said certain content provider is identical with said content identifier included in packets transmitted from said user terminal, and wherein said part of said packet rates is returned back to said certain content provider in accordance with said access data.

23. The gateway as set forth in claim 20, wherein said content identifier is comprised of a universal resource locator (URL).

24. The gateway as set forth in claim 22, wherein said access data includes an amount of packets transmitted to said user terminal.

25. The gateway as set forth in claim 22, wherein said access data includes the number of access made to each of said content providers.

26. The gateway as set forth in claim 22, wherein said access data includes a period of time in which said user terminal makes communication with said certain content provider.
